(19) United States
(12) Patent Application Publication
(10) Pub. No.: US 2010/0301823 A1
(43) Pub. Date: Dec. 2, 2010

(54) POWER SUPPLY UNIT AND CONTROL CIRCUIT OF POWER SUPPLY UNIT

(75) Inventors: Takuya ISHIGAKI, Hitachinaka (JP); Koji TATENO, Takasaki (JP)

Correspondence Address: BRUNDIDGE & STANGER, P.C., 2318 MILL ROAD, SUITE 1020, ALEXANDRIA, VA, 22314, US

(73) Assignee: RENESAS ELECTRONICS CORPORATION, Kawasaki-shi (JP)

(21) Appl. No.: 12/783,250

(22) Filed: May 19, 2010

(30) Foreign Application Priority Data
May 27, 2009 (JP) 2009-128011

(51) Int. Cl. G05F 1/10

(52) U.S. Cl. 323/283

(57) ABSTRACT

An ADC, a comparator, a calculator and a DPWM for applying a feedback control to a power supply main circuit are provided on a control circuit. The comparator compares digital output voltage information obtained by analog to digital conversion of the ADC and target voltage information, and outputs its difference to an error adjuster. The error adjuster performs control by reference to the difference (error value information) so that an output voltage of the power supply main circuit is not included in a predetermined range adjacent to the resolution boundary of the power supply control signal, thereby preventing the occurrence of distortion (limit cycle oscillation) of the output voltage caused by the accumulation of errors.

### CROSS-REFERENCE TO RELATED APPLICATION

The present application claims priority from Japanese Patent Application No. 2009-128011 filed on May 27, 2009, the content of which is hereby incorporated by reference into this application.

### TECHNICAL FIELD OF THE INVENTION

The present invention relates to a digital control method of a power supply unit, and more particularly to a control method of a DC to DC converter or the like for converting a direct-current input voltage to a direct-current output voltage and a digital IC for executing the control method.

### BACKGROUND OF THE INVENTION

A power supply unit is a device having an electric circuit for obtaining a desired output voltage from an input voltage. The digital control has become common also in the power supply unit, but the truncation of information occurs at at least two places in the digital control of the power supply unit. The one is an analog to digital converter (ADC) which converts analog output voltage information to a digital signal. The other is a digital adjusted pulse width modulation generator (DPWM).

Due to this information truncation at two places, a limit cycle is formed in a digital control power supply unit, and the output voltage oscillation (limit cycle oscillation) occurs. The following method can be adopted to prevent the formation of this limit cycle. Assuming that the voltage width quantized by ADC is defined as ΔVadc and the voltage width quantized by DPWM is defined as ΔVpwm, the limit cycle oscillation can be prevented when the following expression 1 is satisfied.

ΔVadc≧ΔVpwm (Expression 1)

However, an additional circuit is needed for reducing ΔVpwm. Due to the additional circuit, demerits such as the loss increase and the cost increase are caused.

Japanese Patent Application Laid-Open Publication No. 10-109656 (Patent Document 1) discloses the means for suppressing the limit cycle oscillation. In this Patent Document 1, the values of the lower bits to be truncated are returned and added to the input signal by using a quantization error reduction circuit, so that the values to be truncated can be reduced.

### SUMMARY OF THE INVENTION

However, in the method of the Patent Document 1 described above, the limit cycle oscillation is left depending on the relation of the expression 1 and the target voltage.

An object of the present invention is to provide a high-accuracy, low-cost and low-loss digital control IC and a digital control power supply unit using the digital control IC.

The above and other objects and novel characteristics of the present invention will be apparent from the description of the present specification and the accompanying drawings.

The typical ones of the inventions disclosed in the present application will be briefly described as follows.

A power supply unit according to a typical embodiment of the present invention comprises: a power supply main circuit; and a control circuit operated by a reference operation clock, wherein the control circuit forms a feedback circuit which quantizes analog output voltage information output from the power supply main circuit based on the reference operation clock as digital output voltage information and controls an output voltage of the power supply main circuit by means of a pulse width modulation using a power supply control signal generated based on counter information having a pulse width equal to an integral multiple of the reference operation clock to the power supply main circuit by using the digital output voltage information, and the control circuit performs control so that the digital output voltage information is not included in a predetermined range adjacent to a resolution boundary of the power supply control signal.

A control circuit of a power supply unit according to a typical embodiment of the present invention is operated based on a reference operation clock, has analog output voltage information as an input signal and has a power supply control signal as an output signal, wherein the control circuit performs control so that digital output voltage information is not included in a predetermined range adjacent to a resolution boundary of the power supply control signal, the control circuit forms a feedback circuit including an ADC, a comparator, a calculator and a DPWM, the ADC quantizes the analog output voltage information to the digital output voltage information based on the reference operation clock, the comparator outputs a difference between target voltage information and the digital output voltage information as error value information, the calculator outputs control amount information based on the error value information to the DPWM, and the DPWM generates and outputs the power supply control signal with reference to counter information having a pulse width equal to an integral multiple of the reference operation clock.

The control circuit of a power supply unit further comprises: an error adjuster for correcting the target voltage information based on the error value information.

The control circuit further comprises: an error adjuster for correcting the digital output voltage information based on the error value information.

The control circuit of a power supply unit further comprises: an error adjuster for correcting the error value information input to the calculator based on the error value information.

The control circuit of a power supply unit further comprises: an error adjuster for correcting the control amount information based on the error value information.

The control circuit of a power supply unit further comprises: an error adjuster for correcting the control amount information output from the calculator based on the error value information.

The effects obtained by typical embodiments of the invention disclosed in the present application will be briefly described below.

By using the digital control IC of the power supply unit according to the typical embodiment of the present invention, even if ΔVpwm≧ΔVadc, when the target voltage is set to the level quantized by the ADC in the upper and lower dead zones of the level quantized by the DPWM, the target voltage information can be avoided from the level quantized by the ADC. By this means, the latent state of the error value information can be prevented, and the large limit cycle oscillation due to the error value information does not occur. By the effect above, the control accuracy of the output voltage is increased, and further, since the additional circuit for reducing ΔVpwm becomes unnecessary, the loss and the cost can be reduced.

Accordingly, it is possible to provide a high-accuracy, low-cost and low-loss digital control IC and a digital control power supply unit using the digital control IC.

### BRIEF DESCRIPTIONS OF THE DRAWINGS

FIG. 1 is a block diagram showing a digital control IC according to the present invention and a configuration of a power supply unit to which the digital control IC is applied;

FIG. 2 is a conceptual diagram showing an example of resolution of an ADC and resolution of a DPWM converted to an output voltage and dead zones of target voltage information according to the present invention;

FIG. 3 is a waveform diagram showing the case where the target voltage information exists in the dead zone according to the present invention;

FIG. 4 is a waveform diagram showing the case where the target voltage information is avoided from the dead zone according to the present invention;

FIG. 5 is a timing chart of the power supply unit centering on the operations of the error adjuster and the adder according to the first embodiment of the present invention;

FIG. 6 is a block diagram showing a configuration of a modification example of the first embodiment of the present invention;

FIG. 7 is a block diagram showing a configuration of another modification example of the first embodiment of the present invention;

FIG. 8 is a block diagram showing a configuration of still another modification example of the first embodiment of the present invention;

FIG. 9 is a block diagram showing a configuration of still another modification example of the first embodiment of the present invention;

FIG. 10 is a block diagram showing a configuration of still another modification example of the first embodiment of the present invention; and

FIG. 11 is a timing chart of the power supply unit centering on the operations of the error adjuster and the adder according to the second embodiment of the present invention.

### DESCRIPTIONS OF THE PREFERRED EMBODIMENTS

Hereinafter, embodiments of the present invention will be described with reference to the accompanying drawings.

### First Embodiment

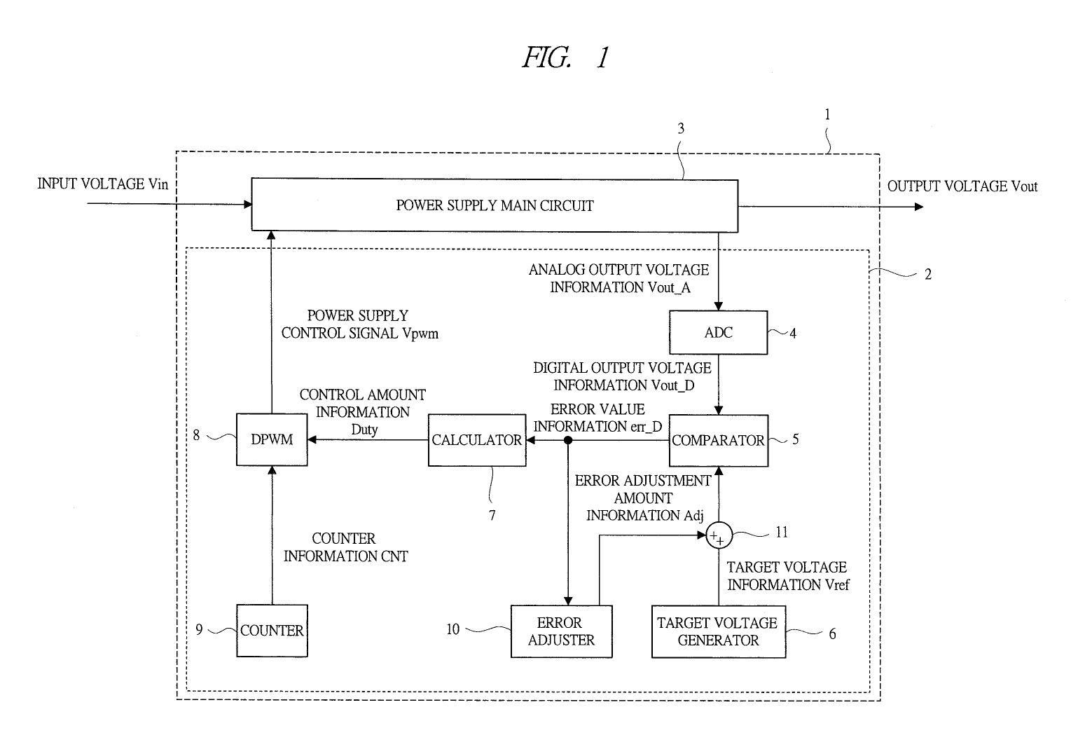

FIG. 1 is a block diagram showing a digital control IC 2 according to the present invention and a configuration of a power supply unit 1 to which the digital control IC 2 is applied.

The power supply unit 1 is made up of the digital control IC 2 and a power supply main circuit 3.

The power supply main circuit 3 is a power supply circuit which receives an input voltage Vin and outputs a desired output voltage Vout after applying appropriate processes. There are various types such as a switching power supply and others for the power supply main circuit 3, but the power supply main circuit 3 is provided only as the object to be controlled, and the type of the power supply main circuit 3 is not considered in the present invention. However, the power supply main circuit 3 is required to output analog output voltage information Vout_A to the digital control IC 2 and receive and appropriately adjust a power supply control signal Vpwm from the digital control IC 2.

Also, although the analog output voltage information Vout_A and the output voltage Vout are denoted by different reference symbols and treated as different signals in FIG. 1, the same signals maybe output to both of them. The relation therebetween is a design matter.

The digital control IC 2 is a digital control IC including a power supply control circuit for controlling the power supply main circuit 3. The digital control IC 2 is made up of an ADC 4, a comparator 5 , a target voltage generator 6, a calculator 7, a digital adjusted pulse width modulation generator (hereinafter, DPWM) 8, a counter 9, an error adjuster 10 and an adder 11. These constituent components are operated based on a reference operation clock (not illustrated).

The ADC 4 is an analog to digital converter (ADC) which converts the analog output voltage information Vout_A output from the power supply main circuit 3 to a digital format. At this conversion, the “rounding” of the error is carried out, and this corresponds to the “information truncation”. The value after the conversion to the digital data, that is, the digital output voltage information Vout_D is output to the comparator 5.

The comparator 5 is a comparator which compares the output of the ADC 4 (digital output voltage information Vout_D) with the output of the adder 11. The error between these two inputs is output as error value information err_D. The output destinations are the calculator 7 and the error adjuster 10.

The target voltage generator 6 is a circuit which defines the voltage value output by the power supply main circuit 3. The output of the target voltage generator 6 is a digital value because it is input to the comparator 5 through the adder 11. This output of the target voltage generator 6 corresponds to the target voltage information Vref.

The calculator 7 is a calculation circuit which outputs control amount information Duty for controlling the DPWM 8 based on the error value information err_D received from the comparator 5.

The DPWM 8 is a digital control circuit which outputs the power supply control signal Vpwm for controlling the output of the power supply main circuit 3 with reference to the output of the counter 9.

The counter 9 is a counter circuit which outputs counter information CNT to be a reference of the output of the DPWM 8 (power supply control signal Vpwm). This counter 9 outputs the counter information CNT at an n-th count (n: integer equal to or larger than 1) of the reference operation clock (not illustrated).

The error adjuster 10 is a circuit serving as a principal part of the present invention. After receiving the error value information err_D output from the comparator 5, the error adjuster 10 outputs error adjustment amount information Adj to the adder 11. The output operation of the error adjustment amount information Adj will be described later.

The adder 11 is an adder circuit which adds the error adjustment amount information Adj output from the error adjuster 10 to the target voltage information Vref output from the target voltage generator 6, thereby correcting the object to be compared by the comparator 5.

Among those described above, the ADC 4, the comparator 5, the target voltage generator 6, the calculator 7, the DPWM 8 and the counter 9 are conventionally available feedback circuits, and on the other hand, the error adjuster 10 and the adder 11 are unique to the present invention.

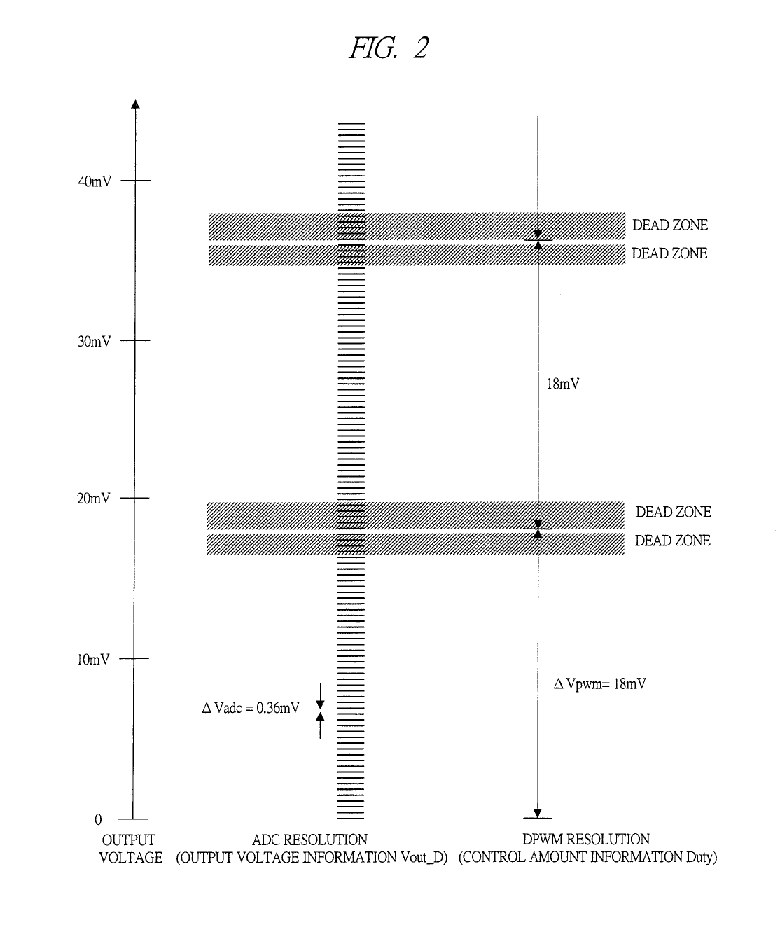

Next, how the error adjuster 10 operates will be described with reference to FIG. 2 to FIG. 4.

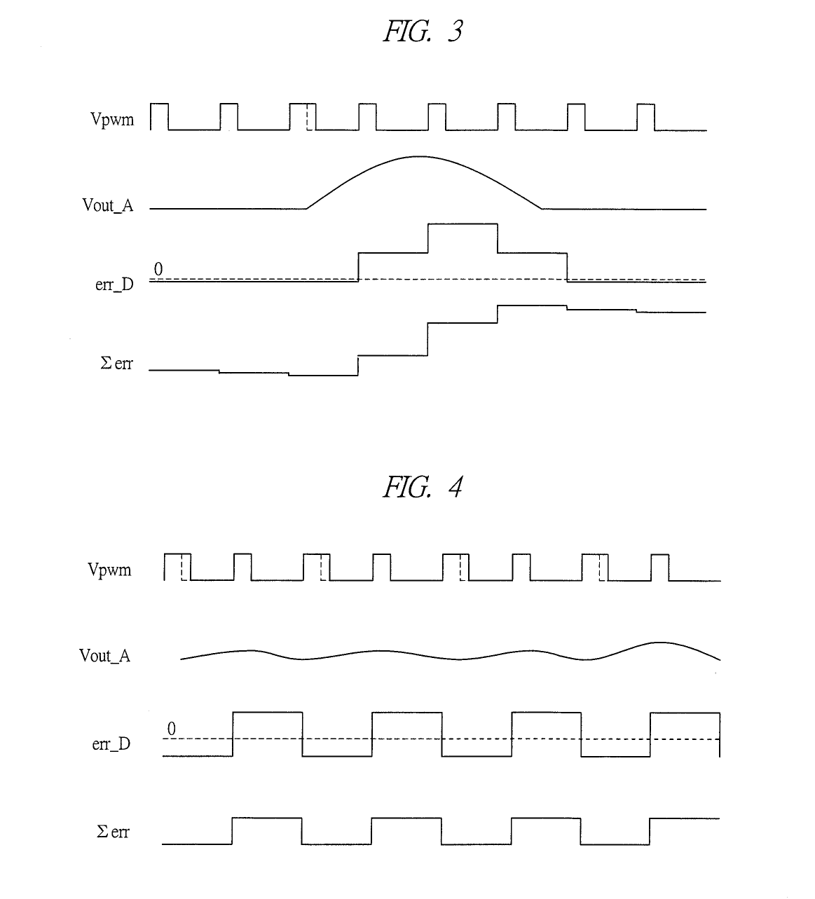

FIG. 2 is a conceptual diagram showing an example of resolution of the ADC 4 and resolution of the DPWM 8 converted to the output voltage and dead zones of the target voltage information Vref according to the present invention. Also, FIG. 3 is a waveform diagram showing the case where the target voltage information Vref exists in the dead zone according to the present invention, and FIG. 4 is a waveform diagram showing the case where the target voltage information Vref is avoided from the dead zone according to the present invention.

The resolution of the control amount information Duty which is a control signal of the DPWM 8 for controlling the power supply main circuit 3 is 18 mV. This is because the power supply control signal Vpwm is generated based on the counter information having a pulse width equal to the integral multiple of the clock.

On the other hand, the resolution of the digital output voltage information Vout_D obtained by quantizing the analog output voltage information Vout_A which is an input from the power supply main circuit 3 is as small as 0.36 mV. This is because, since the subsequent process is digitally performed, the high resolution is more preferable.

As described above, the DPWM 8 generates and outputs the power supply control signal Vpwm based on the counter information CNT. Also, the counter information CNT is equal to the integral multiple of the reference operation clock. More specifically, the resolution of the ADC 4 which performs the quantization with the reference operation clock is 0.36 mV, and on the other hand, the resolution of the DPWM 8 which generates the power supply control signal Vpwm with the counter information CNT is 18 mV (50 times as large as 0.36 mV). This gap in resolution causes the problem. Note that the resolution of the control amount information Duty and the resolution of the digital output voltage information Vout_D are respectively design matters, and they differ depending on the actual products.

The “dead zone” frequently mentioned in the following description will be first defined. The “dead zone” corresponds to the zone near the “boundary” of the next clock with the resolution of the DPWM 8 operated based on the counter information CNT. More specifically, the output of the DPWM 8 has the pulse width of “counter information CNT×n” before reaching the “boundary” , and it has the pulse width of “counter information CNT×(n+1)” after reaching the “boundary”. The predetermined zone before or after the “boundary” is defined as the “dead zone”. FIG. 2 visually shows this dead zone. This dead zone is the design matter changed depending on the power supply main circuit 3 to be controlled and the voltage Vout output by the power supply main circuit 3.

When the target voltage information Vref exists in the dead zone, the output voltage Vout of the power supply main circuit 3 is kept constant until the power supply control signal Vpwm is input a predetermined number of times. However, the accumulation of the error value information err_D occurs during this period. When the accumulation of the error of the error value information err_D (Σerr at the bottom of FIG. 3) reaches the predetermined amount or more, the output of the DPWM 8 is changed from the pulse width of “counter information CNT×n” to the pulse width of “counter information CNT×(n+1)”. Since the digital control is performed, it is not possible to take the intermediate pulse width between the pulse width of “counter information CNT×n” and the pulse width of “counter information CNT×(n+1)”.

Therefore, at the point where the pulse width of the power supply control signal Vpwm changes, the output voltage Vout of the power supply main circuit 3 is significantly distorted as shown in FIG. 3. In FIG. 3, the pulse width greatly changes at the third pulse of the power supply control signal Vpwm, and the output fluctuation of the output voltage Vout of the power supply main circuit 3 continues to the sixth and seventh pulses of the power supply control signal Vpwm where the error of the error value information err_D converges. However, the output fluctuation of the output voltage Vout of the power supply main circuit 3 like this is obviously inadequate for the operation of the power supply circuit for “obtaining a desired output voltage from an input voltage”.

The large distortion shown in FIG. 3 is intermittently generated as being close to upper and lower adjacent ranges of the output level of the DPWM 8 quantized based on the counter information CNT. Therefore, the dead zone is set in the range where the large distortion is not generated. This is the reason for providing the dead zone. Further, in the embodiment of the present invention, the control is performed so that the target voltage information Vref is not located in the range of the dead zone.

More specifically, in the present invention, the error value information err_D is increased so that the error value information err_D is not located in the dead zone as shown in FIG. 4. Whether or not the target voltage information Vref exists in the dead zone can be checked by acquiring the error value information err_D. More specifically, as can be understood from FIG. 2, the resolution of the error value information err_D is 0.36 mV and is smaller than the resolution of the DPWM 8 (18 mV). Therefore, the error value information err_D is preferably expressed as “it is increased (decreased) from the current voltage level by the resolution of X”, and this expression is available.

When the error value information err_D is located in the dead zone, the error adjuster 10 outputs the error adjustment amount information Adj so that the error value information err_D is displaced from the dead zone, and the adder 11 carries out an operation of the output of the target voltage information Vref and the error adjustment amount information Adj.

Since the error value information err_D greatly fluctuates, the Σerr which is the accumulation of the errors of the error value information err_D also greatly fluctuates. However, since the error value information err_D continuously oscillates from positive to negative or otherwise at each pulse of the power supply control signal Vpwm, the Σerr continues to always change. Accordingly, the output voltage Vout of the power supply main circuit 3 also always changes as shown in FIG. 4, but the information is not accumulated as the Σerr due to it. As a result, the amount of change thereof is reduced compared with that of FIG. 3. In this manner, it is possible to withstand the practical use as a power supply circuit.

Note that whether the case where the error adjustment is not necessary (case where error value information err_D=0) is set as the dead zone is the design matter.

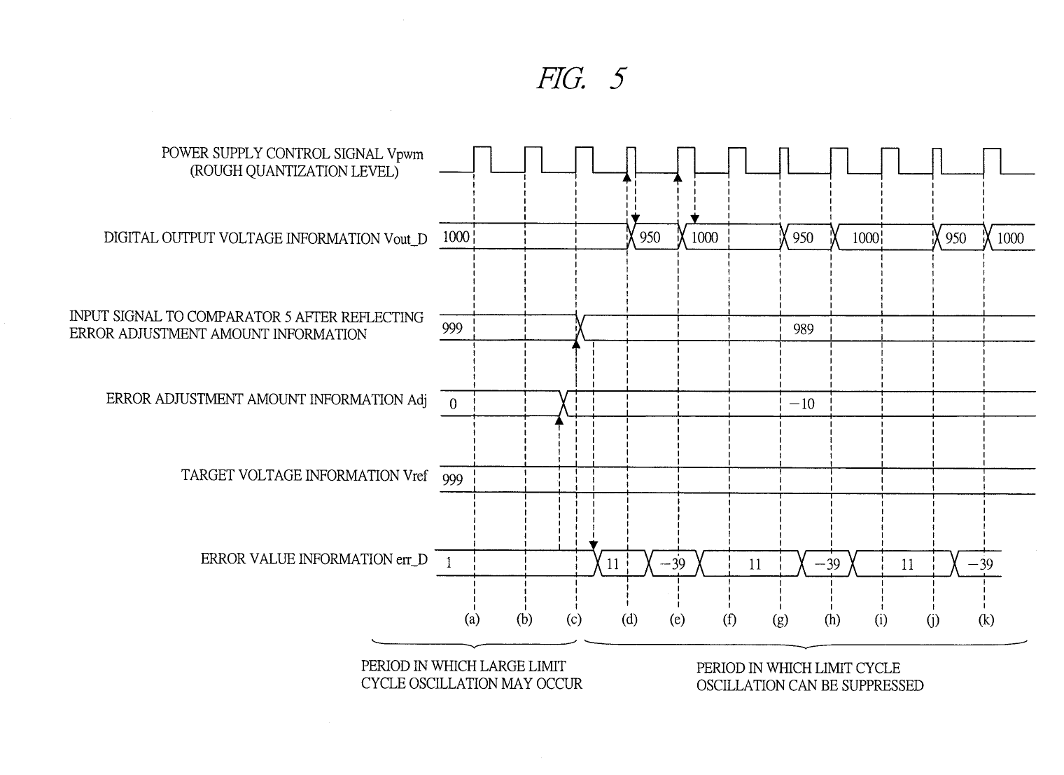

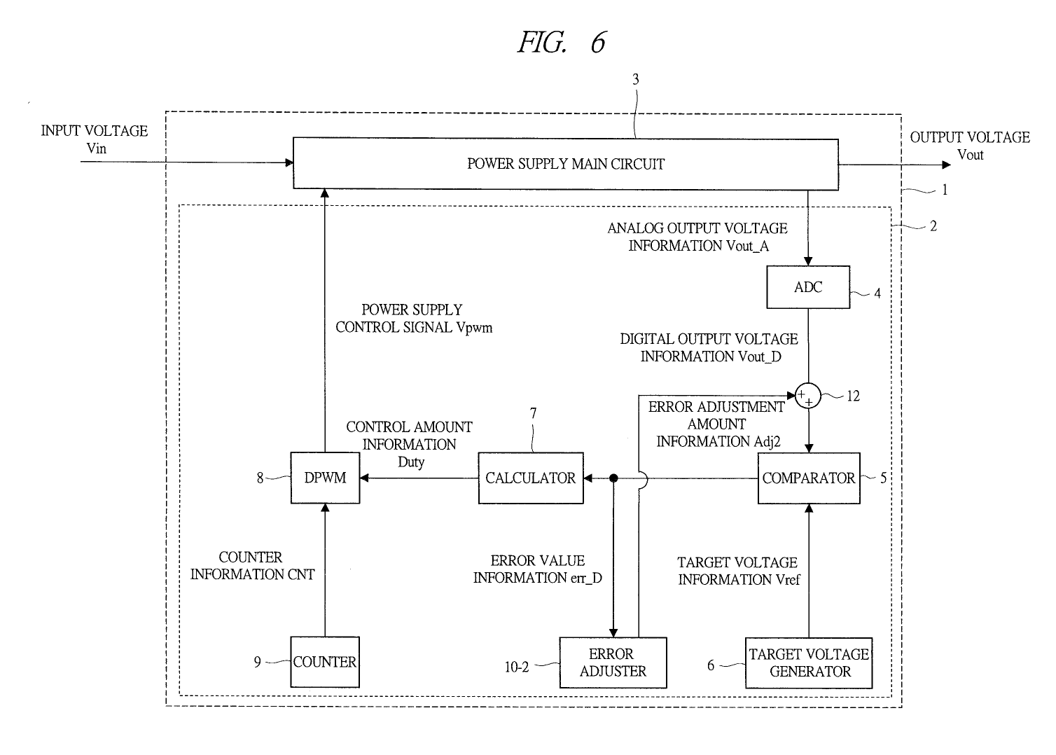

Also, the modification example is conceivable, in which the process is continued as it is without performing the adjustment before reaching the predetermined number of times even when the error value information err_D exists in the dead zone. This is true of the next case of FIG. 5.

How the error adjuster 10 and the adder 11 operate will be described more concretely with reference to FIG. 5. FIG. 5 is a timing chart of the power supply unit 1 centering on the operations of the error adjuster 10 and the adder 11 according to the present invention. Note that the output of the target voltage generator 6 is fixed to 999 in FIG. 5.

At the timings (a) and (b) of FIG. 5, the error adjuster 10 is not particularly operated, and the error adjustment amount information Adj is 0. Also, at the start point, the output voltage information Vout_D output from the ADC 4 is 1000, and the error value information err_D is 1. More specifically, it can be said that it is in the state where the above-described Σerr is accumulated.

However, when the request of avoiding the target voltage information Vref from the dead zone is generated between the timings (b) and (c) by a predetermined trigger, the error adjuster 10 outputs −10 as the error adjustment amount information Adj. Then, the adder 11 adds the value of −10 of the error adjustment amount information Adj to the value of 999 of the target voltage information and outputs the value of 989 to the comparator 5 (timing (c)).

Accordingly, the objects to be compared by the comparator 5 become the output of 989 of the adder 11 and the value of 1000 of the output voltage information Vout_D. Therefore, the comparator 5 outputs the value of 11 as the error value information err_D.

Upon reception of it, after passing through the calculator 7, the DPWM 8 outputs the power supply control signal Vpwm (timing (d)). However, the power supply control signal Vpwm has low resolution and can perform the adjustment of the pulse width only in units of 18 mV (see FIG. 2). Therefore, the power supply main circuit 3 receives the power supply control signal Vpwm with a short pulse width and drops the voltage. As a result, the value after the conversion of ADC 4, that is, the output voltage information Vout_D is also greatly changed to take the value of 950.

Accordingly, the objects to be compared by the comparator 5 become the output of 989 of the adder 11 and the value of 950 of the output voltage information Vout_D. Therefore, the comparator 5 outputs the value of −39 as the error value information err_D (between timings (d) and (e)). As a result, the pulse width of the power supply control signal Vpwm is increased in order to improve the output voltage, and the output voltage information Vout_D returns to 1000 (timing (e)).

At the next timing (f), the output voltage information Vout_D remains 1000 in FIG. 5. However, this is due to the limits of the expression of the drawing attached to the specification, and this timing (f) continues several times in an actual case. The reason therefor is as follows.

That is, in the present embodiment, the output of the target voltage generator 6 is 999. In order to output it, 950 has to be output once and 1000 has to be output 49 times as the output voltage information Vout_D. This will be understood from the following expression 2.

(1000×A+950×B)/50=999 (Expression 2)

Assuming that the variable A of this expression 2 is 49 and the variable B is 1, 999 of the right-side member can be satisfied. The determination of the value of these variables can be obtained by the error adjuster 10.

In FIG. 5, the period from the timing (d) to the timing (g) (=period in which the power supply control signal Vpwm is output three times) is defined as one set, and in the period from the timing (g) to the timing (j), the ratio in the number of times of the output of 1000 and the output of 950 of the output voltage information Vout_D is set to 2:1. However, it should be noted that the “999” which is the output of the target voltage generator 6 cannot be achieved in practice unless the ratio in the number of times of the output of 1000 and the output of 950 of the output voltage information Vout_D becomes 49:1 during the period when the power supply control signal Vpwm is output 50 times.

The error adjuster 10 is required to dynamically obtain the error adjustment amount Adj with reference to the composition ratio of the output voltage information Vout_D. As part of it, the error adjustment amount information Adj is changed from 0 to −10 just before the timing (c) in FIG. 5.

By providing the configuration and the dead zone in the above-described manner and controlling the output voltage Vout of the power supply main circuit 3 so as to avoid the dead zone, it becomes possible to prevent the large distortion of the output voltage Vout.

Note that an example obtained by appropriately modifying the present embodiment is also included in the present invention. Such modification examples will be described below.

FIG. 6 is a diagram showing a configuration of a modification example of the first embodiment of the present invention. In this modification example, an adder 12 is provided instead of the adder 11. Thus, the error adjuster 10 is also replaced with an error adjuster 10-2.

This adder 12 is inserted between the ADC 4 and the adder 5. This adder 12 adds the output Vout_D of the ADC 4 and error adjustment amount information Adj2 which is an output of the error adjuster 10-2. In the present embodiment, the output of the adder 12 and the target voltage information Vref which is an output of the target voltage generator 6 are compared by the comparator 5.

More specifically, it shows that the same process can be performed even if the object of the error adjustment is replaced from the target voltage information Vref to the digital output voltage information Vout_D.

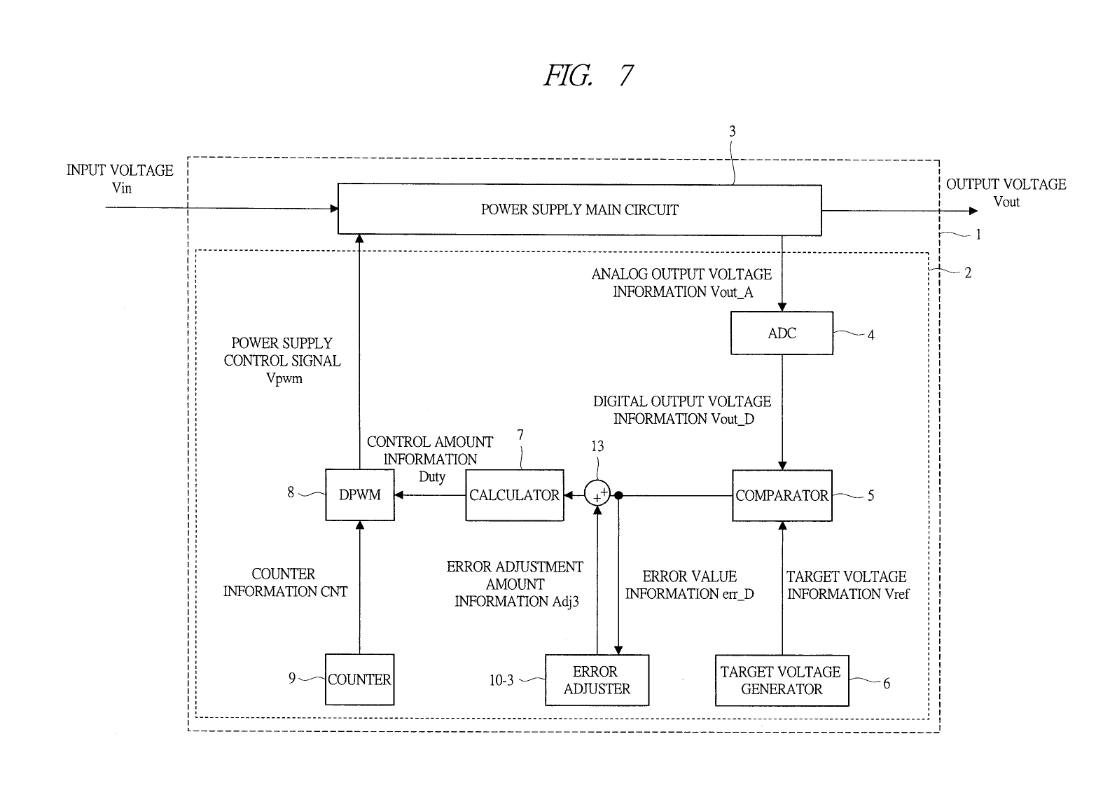

FIG. 7 is a diagram showing a configuration of another modification example of the first embodiment of the present invention. In this modification example, an adder 13 is provided instead of the adder 11. Thus, the error adjuster 10 is also replaced with an error adjuster 10-3.

This adder 13 is inserted between the adder 5 and the calculator 7. This adder 13 adds the error value information err_D output from the comparator 5 and error adjustment amount information Adj3 which is an output of the error adjuster 10-3 . Also by inputting the output of the adder 13 to the calculator 7, the control of the power supply control signal Vpwm can be performed in the same manner as FIG. 1.

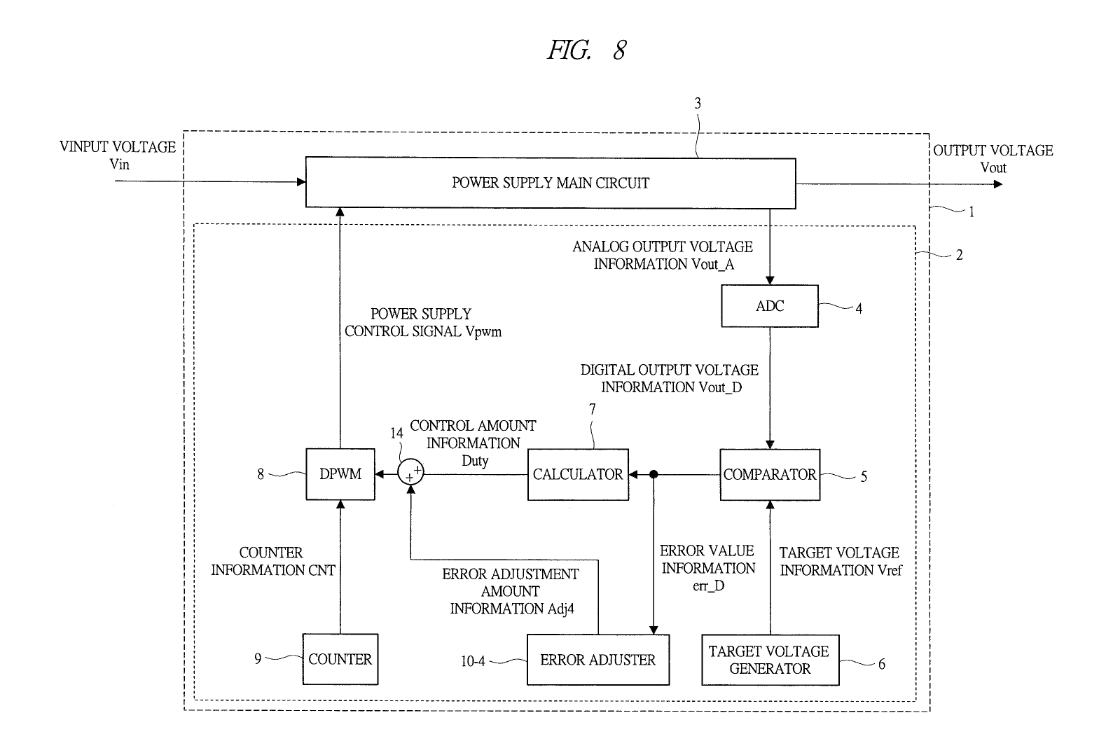

FIG. 8 is a diagram showing a configuration of still another modification example of the first embodiment of the present invention. In this modification example, an adder 14 is provided instead of the adder 11 . Thus, the error adjuster 10 is also replaced with an error adjuster 10-4.

This adder 14 is inserted between the calculator 7 and the DPWM 8. This adder 14 adds the control amount information Duty which is the output of the calculator 7 and error adjustment amount information Adj4 which is an output of the error adjuster 10-4. By inputting the output of the adder 14 to the DPWM 8, the control of the power supply control signal Vpwm can be performed in the same manner as FIG. 1.

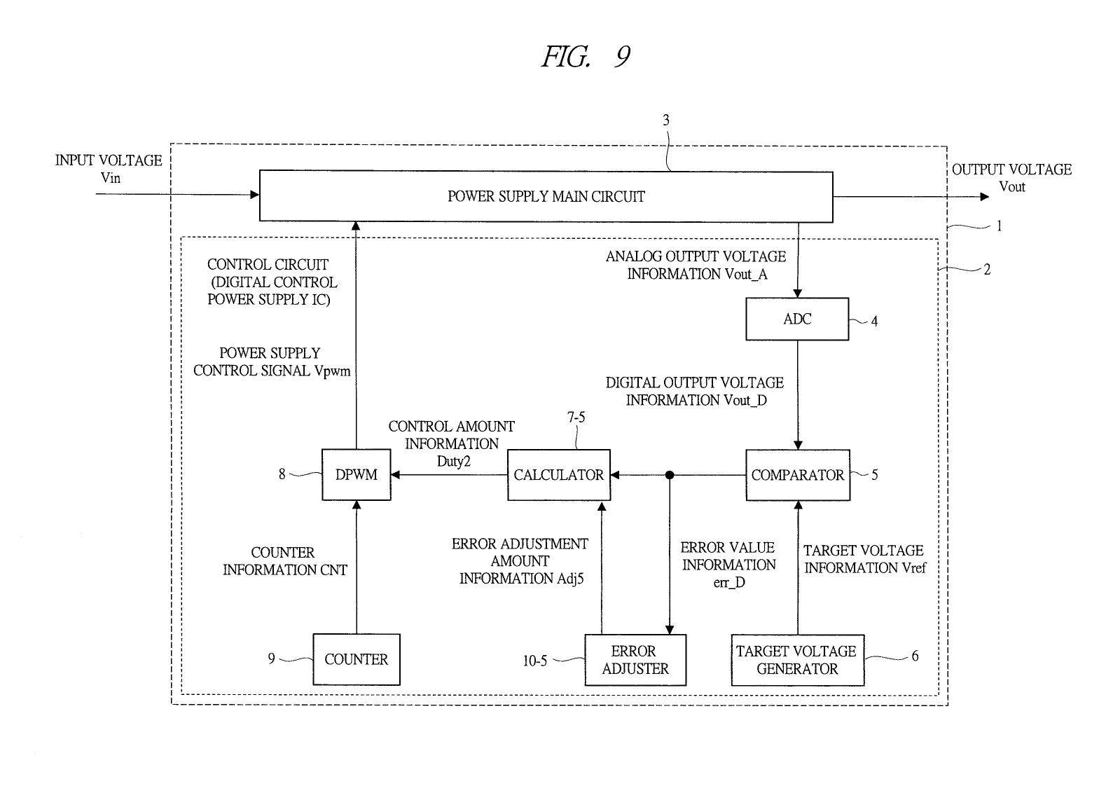

Further, the power supply control signal Vpwm is controlled by adding the output of a specific module and the output of the error adjuster so far. However, the case where the output of the error adjuster is input to a specific module to adjust the output itself of the module is also conceivable. FIG. 9 is a diagram showing a configuration of still another modification example of the first embodiment of the present invention. In this modification example, no adder is used. Also, the error adjuster 10 is replaced with an error adjuster 10-5, and the calculator 7 is replaced with a calculator 7-5.

The calculator 7-5 is different from that of FIG. 1 in that error adjustment amount information Adj5 output from the error adjuster 10-5 is used as a parameter of control amount information Duty2.

More specifically, the error value information err_D which is an output from the comparator 5 is input to the error adjuster 10-5. The error adjuster 10-5 outputs the error adjustment amount information Adj5 to the calculator 7-5 by using this error value information err_D.

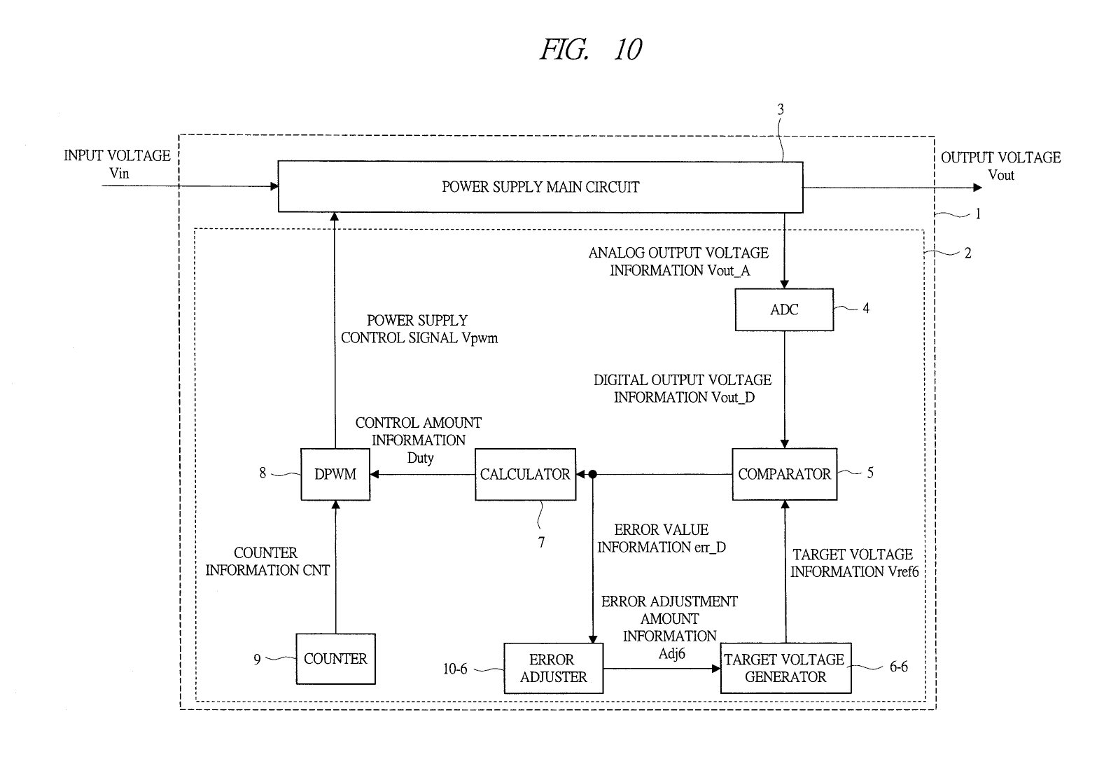

FIG. 10 is a diagram showing a configuration of still another modification example of the first embodiment of the present invention. Also in this modification example, no adder is used. The error adjuster 10 is replaced with an error adjuster 10-6, and the target voltage generator 6 is replaced with a target voltage generator 6-6.

Different from the target voltage generator 6, the output voltage of this target voltage generator 6-6 is changed by error adjustment amount information Adj6 which is an output of the error adjuster 10-6. This output voltage is target voltage information Vref6.

Although the objects to be compared by the comparator 5 are changed by changing the value to be output to the adder 11 in the case of FIG. 1, the same effect can be achieved by changing the output itself of the target voltage generator 6-6 in the case of FIG. 10.

### Second Embodiment

Next, a second embodiment of the present invention will be described.

The power supply unit outputs a desired voltage to a load circuit. The load on the load circuit connected to the power supply unit is constant in some cases and is changed depending on situations in other cases.

In the present embodiment, how to respond to the fluctuation of the load circuit is considered. Note that, since the circuit configuration is the same as that of FIG. 1, only the behavior on the circuit will be described here.

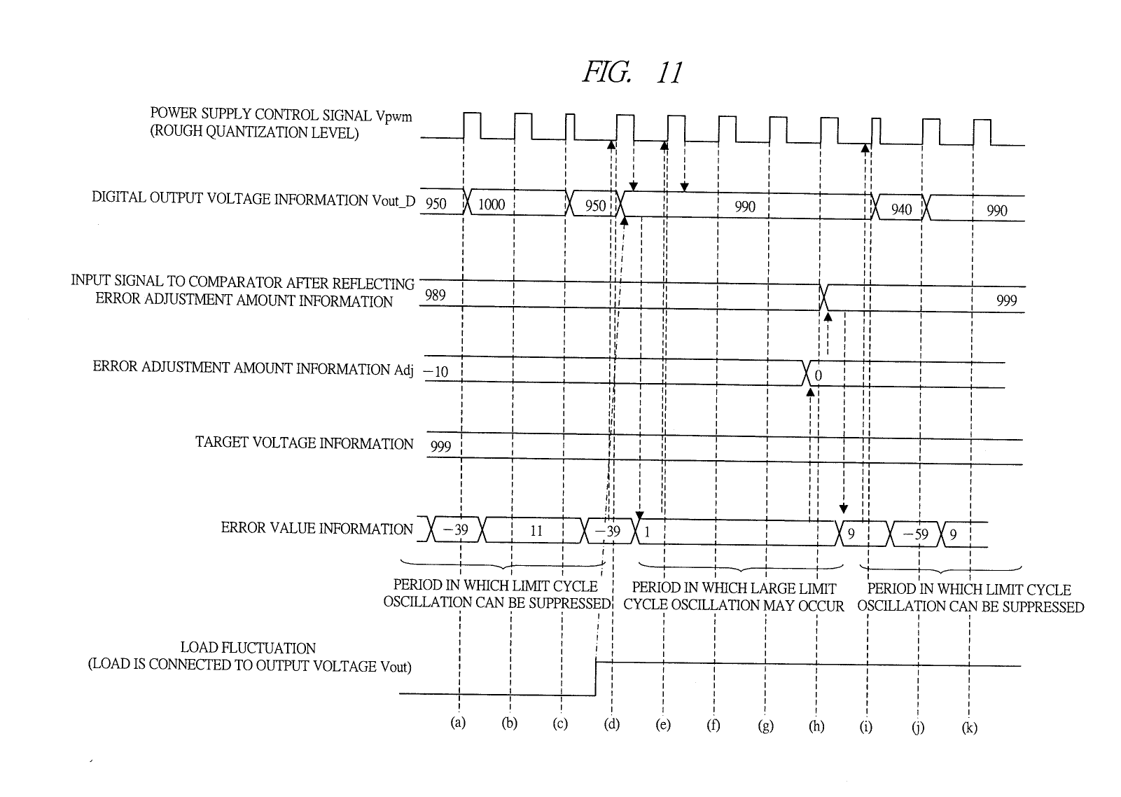

FIG. 11 is a timing chart of the power supply unit centering on the operations of the error adjuster 10 and the adder 11 according to the second embodiment of the present invention.

In FIG. 11, the period from the timing (a) to the timing (d) just after the occurrence of the load fluctuation is the same as the period from the timing (d) to the timing (g) of the first embodiment. Therefore, three power supply control signals Vpwm are included in 1 set in FIG. 11, but there is the possibility that more power supply control signals Vpwm are included like in the first embodiment.

When the load fluctuation occurs (just before the timing (d)), the digital output voltage information Vout_D corresponding to the output of the power supply unit is also changed. This is the reason why the digital output voltage information Vout_D takes the value of 990, which is essentially impossible in a spontaneous manner (in view of resolution), at the timing (d).

When the value of the digital output voltage information Vout_D fluctuates due to the fluctuation of the outer load (load outside the power supply unit in this case) as described above, the initially-assumed dead zone itself is moved. More specifically, the error value information err_D output from the comparator 5 takes an unexpected value, and it raises the possibility that the information is accumulated as the Σerr. It corresponds in FIG. 11 to the error value information err_D being 1 due to the load fluctuation at the timing (d).

There is the possibility that the large limit cycle oscillation shown in FIG. 3 occurs during this period. This is the “period in which large limit cycle oscillation may occur” after the error value information err_D becomes 1 from the timing (d) in FIG. 11.

Thereafter, the error adjustment amount is derived by the error adjuster 10. The result thereof is output to the adder 11 as the error adjustment amount information. In FIG. 11, it is expressed by the change of the error adjustment amount information Adj from −10 to 0 just before the timing (h).

As a result, the added value of the target voltage information Vref and the error adjustment amount information Adj input to the comparator 5 is also changed. This corresponds to the change of the input signal to the comparator after reflecting the error adjustment amount information from 989 to 999 just after the timing (h).

By this means, the error value information err_D becomes 9. As a result, the object to be controlled of the DPWM 8 (=power supply output Vout) is displaced from the dead zone.

After that, similar to the first embodiment, the number of times that the digital output voltage information Vout_D takes the values of 990 and 940 is derived, and the process is performed based on the result thereof in the same manner as the first embodiment.

As described above, even when the power supply output Vout of the power supply unit changes due to the occurrence of the fluctuation of the outer load or the like, the occurrence of the large limit cycle oscillation can be prevented by applying the present embodiment.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention has been described based on a method effective when digitally controlling a DC to DC converter and a digital control IC which performs the method. However, other than those, the present invention can be applied also to an AC to DC converter and a DC to AC converter controlled digitally.

What is claimed is:

1. A power supply unit comprising: a power supply main circuit; and a control circuit operated by a reference operation clock,
wherein the control circuit forms a feedback circuit which quantizes analog output voltage information output from the power supply main circuit based on the reference operation clock as digital output voltage information and controls an output voltage of the power supply main circuit by means of a pulse width modulation using a power supply control signal generated based on counter information having a pulse width equal to an integral multiple of the reference operation clock to the power supply main circuit by using the digital output voltage information, and
the control circuit performs control so that the digital output voltage information is not included in a predetermined range adjacent to a resolution boundary of the power supply control signal.

2. A control circuit of a power supply unit, the control circuit being operated based on a reference operation clock, having analog output voltage information as an input signal and having a power supply control signal as an output signal,
wherein the control circuit performs control so that digital output voltage information is not included in a predetermined range adjacent to a resolution boundary of the power supply control signal,
the control circuit forms a feedback circuit including an ADC, a comparator, a calculator and a DPWM,
the ADC quantizes the analog output voltage information to the digital output voltage information based on the reference operation clock,
the comparator outputs a difference between target voltage information and the digital output voltage information as error value information,
the calculator outputs control amount information based on the error value information to the DPWM, and
the DPWM generates and outputs the power supply control signal in accordance with the control amount information with reference to counter information having a pulse width equal to an integral multiple of the reference operation clock.

3. The control circuit of a power supply unit according to claim 2, further comprising:
an error adjuster for correcting the target voltage information based on the error value information.

4. The control circuit of a power supply unit according to claim 2, further comprising:
an error adjuster for correcting the digital output voltage information based on the error value information.

5. The control circuit of a power supply unit according to claim 2, further comprising:
an error adjuster for correcting the error value information input to the calculator based on the error value information.

6. The control circuit of a power supply unit according to claim 2, further comprising:
an error adjuster for correcting the control amount information output from the calculator based on the error value information.
